(19) United States
(12) Patent Application Publication
(10) Pub. No.: US 2011/0032270 A1
(43) Pub. Date: Feb. 10, 2011

(54) PRESENTATION DEVICE

(76) Inventor: Yasushi Suda, Kasugai (JP)

Correspondence Address: OSTROLENK FABER GERB & SOFFEN, 1180 AVENUE OF THE AMERICAS, NEW YORK, NY, 100368403, US

(21) Appl. No.: 12/849,485

(22) Filed: Aug. 3, 2010

(30) Foreign Application Priority Data
Aug. 5, 2009 (JP) 2009182078

(51) Int. Cl. G09G 5/00

(52) U.S. Cl. 345/619

(57) ABSTRACT

A presentation device 100 comprises an image capture portion for capturing a subject at prescribed time intervals to generate successive raw images; a first storage portion to which the generated raw images are successively saved; a second storage portion to which one of the generated raw images is saved as a still image; a detection portion adapted to analyze raw images stored in the first storage portion to ascertain if a prescribed indicator member is included therein, and if the indicator member is included in the raw images, to detect the location and direction of pointing of the indicator member; a pointer image generation portion adapted to generate a pointer image showing the detected location and direction; a synthesized image generation portions adapted to read out the still image from the second storage portion and synthesize the pointer image with the still image to generate a synthesized image; and an output portion for outputting the synthesized image.

### CROSS-REFERENCE TO RELATED APPLICATION

The present application claims the priority based on Japanese Patent Application No. 2009-182078 filed on Aug. 5, 2009, the disclosure of which is hereby incorporated by reference in its entirety.

### BACKGROUND

1. Field of the Invention

The present invention relates to a presentation device adapted to capture and generate an image of a document, and to display the image on an external display device.

2. Related Art

When making a presentation using a conventional presentation device, it was common practice to directly point to a location in a document using a pointer or similar implement.

However, when the captured video feed is temporarily paused and a still image is displayed, because the pointer is no longer displayed in real time on the display unit, the user had to go over to the display unit or screen in order to point to the intended location on the display image.

To address this issue, JP-A-2004-23359 for example discloses a technique whereby a point image is synthesized on a still image on the basis of the location of an indicator mark of a pen tip detected within the shooting area of the presentation device. However, with this technique, because the pen tip and the point image are completely different in shape, it some instances it was necessary to modify the operation for pointing to a location. Specifically, when a desired location is pointed out by the pen, because the pointing direction is readily apparent there is no need to move the pen tip; however, when a location is pointed out by the point image, the location being pointed to may not be evident unless the point image is moved so as to circle about the intended location.

### SUMMARY

An object of the invention is to provide a presentation device by which any desired location on a document may be pointed out during output of a still image, by an operation comparable to that used during output of a motion video image.

An aspect of the invention is directed to a presentation device. The device includes an image capture portion for capturing a subject at prescribed time intervals to generate successive raw images; a first storage portion to which the generated raw images are successively saved; a second storage portion to which one of the generated raw images is saved as a still image; a detection portion adapted to analyze raw images stored in the first to storage portion to ascertain if a prescribed indicator member is included therein, and if the indicator member is included in the raw images, to detect the location and direction of pointing of the indicator member; a pointer image generation portion adapted to generate a pointer image showing the detected location and direction; a synthesized image generation portions adapted to read out the still image from the second storage portion and synthesize the pointer image with the still image to generate a synthesized image; and an output portion for outputting the synthesized image.

According to this aspect, if the prescribed indicator member is present in raw images successively saved to the first storage portion, the location and direction being pointed to by this indicator member are detected, and the pointer image indicating this location and direction is generated. This pointer image is then synthesized with the still image read from the second storage portion, and output. That is, according to this aspect, the pointer image that points to the location and direction similar to the location and direction pointed to by the indicator member captured by the image capture portion is displayed superimposed on the still image. As a result, any desired location on the document may be pointed out during output of a still image, by an operation comparable to that during output of a motion video image.

In addition to the aspect of the presentation device described above, other aspects of the present invention include a method of controlling or a method of using a presentation device; a computer program; a recording medium having a computer program recorded thereon, and the like.

These and other objects, features, aspects, and advantages of the invention will become more apparent from the following detailed description of the preferred embodiments with the accompanying drawings.

### BRIEF DESCRIPTION OF THE DRAWINGS

FIG. 1 is an exterior view of a presentation device according to an embodiment of the invention;

FIG. 2 is a block diagram depicting the internal configuration of the presentation device;

FIG. 3 is a flowchart of an image display process;

FIG. 4 is an illustration depicting a pointer present in raw image data;

FIG. 5 is an illustration depicting a method of detecting specified location and specified direction;

FIG. 6 is an illustration depicting an example of synthesized image data displayed on a liquid crystal display; and

FIG. 7 is an illustration depicting an example of synthesized image data displayed on a liquid crystal display.

### DETAILED DESCRIPTION OF THE EMBODIMENTS

The embodiments of the invention are described below in the following order.

A. Presentation device Features:

### B. Image Display Process:

### C. Modified Examples:

### A. Presentation Device Features

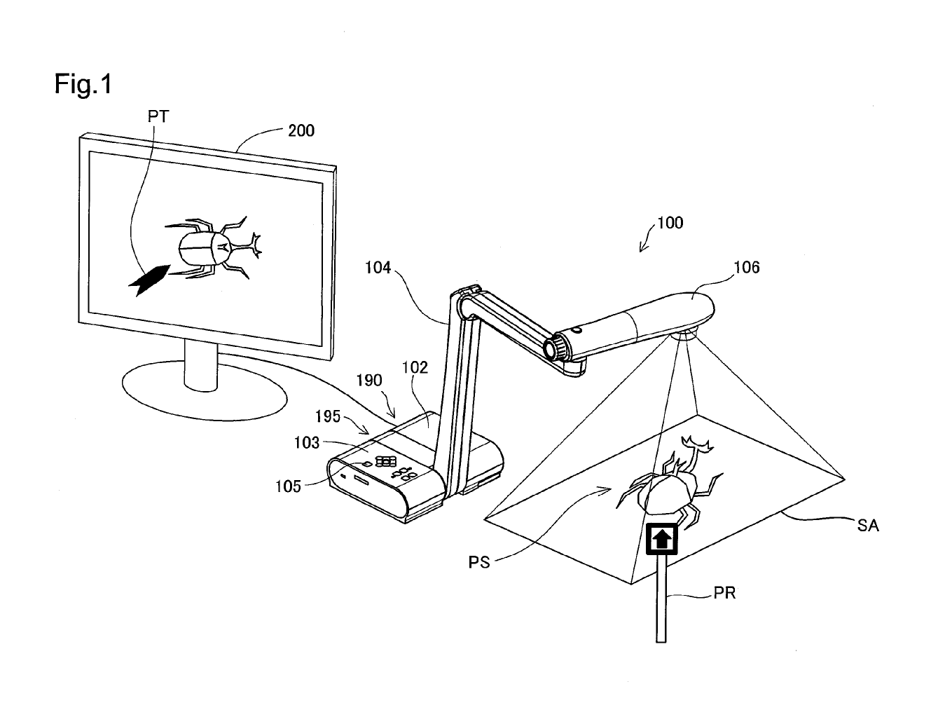

FIG. 1 is an exterior view of a presentation device 100 according to an embodiment of the invention. The presentation device 100 includes a base 102 adapted to be placed on a surface such as a desktop; a control console 103 disposed on the base 102; an articulable support post 104 that extends upward from the base 102, and a camera head 106 mounted on the distal end of the support post 104. The camera head 106 houses a CCD camera, and captures an image of a subject PS that has been positioned on the desktop. A video output terminal 190 and a USB interface 195 are provided on the back face of the base 102. The video output terminal 190 is used to connect a device such as a liquid crystal display 200, a projector, or a television. A computer (not shown) is connected to the USB interface 195. The video output terminal 190 and the USB interface 195 output the image of the subject PS captured by the camera head 106.

The presentation device 100 of the present embodiment is provided with a still image button 105, located in the control console 103, for outputting a still image. When this still image button 105 is pressed, a still image of the subject PS captured by an image capture portion 120 is displayed on the liquid crystal display 200. According to the present embodiment, while a still image is being displayed in this way, if a pointer PR provided as the indicator member is positioned within the shooting area SA of the presentation device 100, a pointer image PT that points to a location and direction similar to the location and direction pointed to by this pointer PR is synthesized onto the still image. The details of the features and processes for accomplishing this function are discussed below.

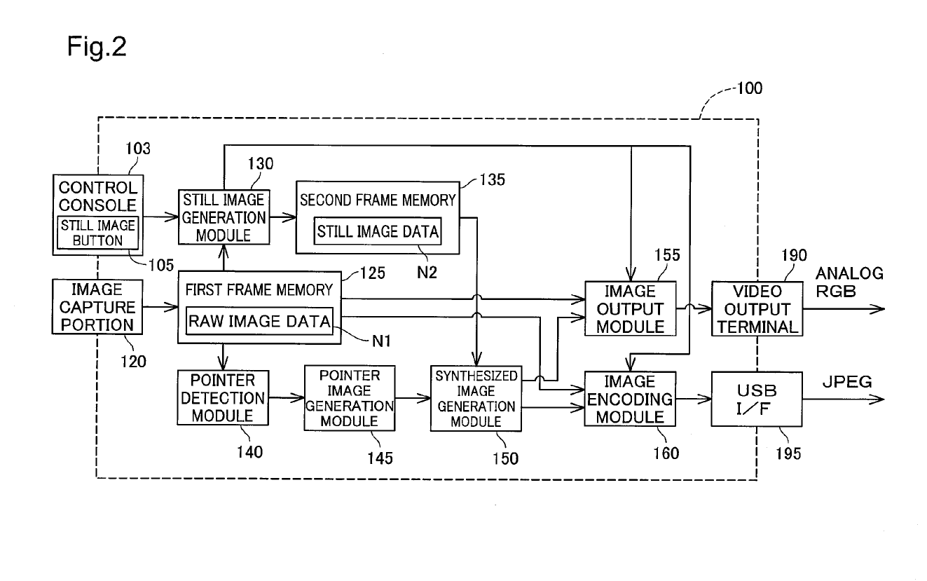

FIG. 2 is a block diagram depicting the internal configuration of the presentation device 100. The presentation device 100 includes the image capture portion 120, a first frame memory 125 provided as the first storage portion, a still image generation module 130, a second frame memory 135 provided as the second storage portion, a pointer detection module 140, a pointer image generation module 145, a synthesized image generation module 150, an image output module 155, and an image encoding module 160. Of these, the still image generation module 130, the pointer detection module 140, the pointer image generation module 145, the synthesized image generation module 150, the image output module 155, and the image encoding module 160 are implemented through hardware, using an ASIC (Application Specific Integrated Circuit).

The image capture module 120 is equipped with a CCD camera housed inside the camera head 106, and an analog front end circuit adapted to convert the analog signal output by the CCD camera to a digital signal. The image capture module 120 takes a 15-frame image every second, and sequentially records the captured image as raw image data N1 in the first flash memory 125.

When the still image button 105 of the control console 103 is pushed, the still image generation module 130 reads out from the first frame memory 125 the raw image data N1 currently recorded at that point in time, and then records this raw image data N1 to the second frame memory 135 as still image data N2. At this time the mode of output of images (hereinafter termed “image output mode”) of the still image generation module 130 is in “still image mode”. When the still image button 105 is pushed again, the image output mode of the still image generation module 130 switches to “motion video mode”. A mode signal representing the current image mode is sent from the still image generation module 130 to the image output module 155 and the image encoding module 160, discussed later. In the present embodiment, the image output mode of the presentation device 100 immediately after being powered on is the “motion video mode”.

The pointer detection module 140 analyzes the raw image data N1 recorded to the first frame memory 125 to determine if it contains an image representing the pointer PR. If as a result of the analysis it is decided that an image representing the pointer PR is present, the pointer detection module 140 additionally detects the location and direction to which the pointer PR is pointing. Herein, the location to which the pointer PR points is termed the “specified location” and the direction in which the pointer PR points is termed the “specified direction”.

The pointer image generation module 145 generates a pointer image PT according to the specified location and specified direction that were detected by the pointer detection module 140.

The synthesized image generation module 150 reads out the still image data N2 that was recorded to the second frame memory 135, and synthesizes the pointer image PT that was generated by the pointer image generation module 145 with this still image data N2 to generate synthesized image data. The synthesized image data generated in this way is output to the image output module 155 and the image encoding module 160.

The image output module 155 carries out D/A conversion and frame rate conversion of raw image data N1 recorded to the first frame memory 125 or synthesized image data generated by the synthesized image generation module 150, and outputs the data from the video output terminal 190 in the form of an RGB signal. Here, the image output module 155 selects the image data for output according to a mode signal received from the still image generation module 130. Specifically, if the received mode signal is a signal representing motion video mode, the raw image data N1 recorded to the first frame memory 125 is output, or if it is a signal representing still image mode, the synthesized image data generated by the synthesized image generation module 150 is output.

The image encoding module 160 encodes into JPEG data the raw image data N1 recorded to the first frame memory 125 or the synthesized image data generated by the synthesized image generation module 150, and outputs the data from the USB interface 195. Like the image output module 155, the image encoding module 160 selects the image data for output according a mode signal received from the still image generation module 130. The image encoding module 160 may perform JPEG encoding and output of JPEG data only when a computer is connected to the USB interface 195.

According to the present embodiment, the first frame memory 125 for storing raw image data N1 and the second frame memory 135 for storing still image data N2 are provided as separate frame memories; however, the raw image data N1 and the still image data N2 could also be saved to individual areas in a single frame memory.

### B. Image Display Process

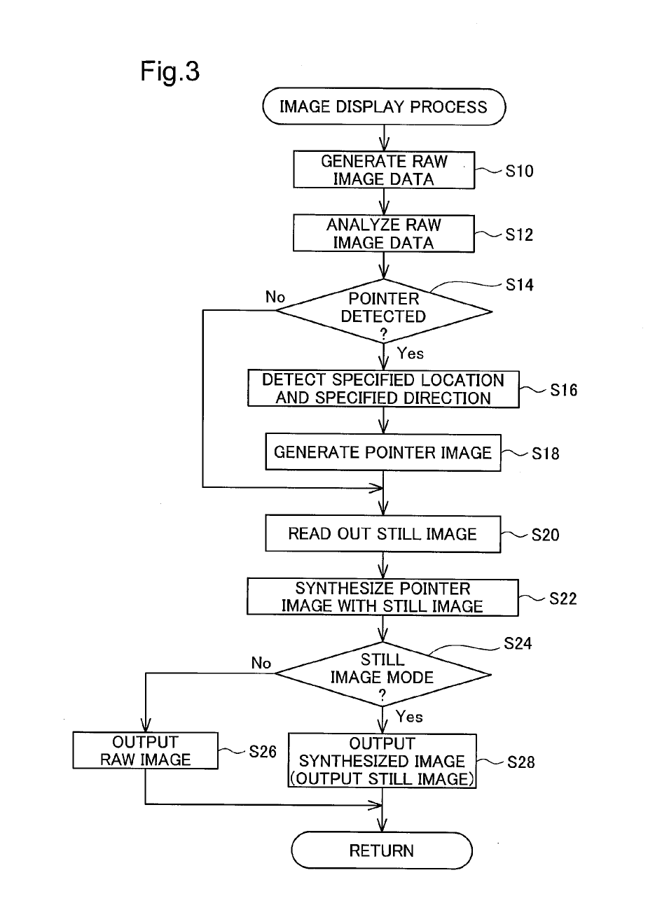

FIG. 3 is a flowchart of the image display process executed cooperatively by the blocks depicted in FIG. 2. This image display process is executed repeatedly during the time that the presentation device 100 is powered on. When this image display process is executed, the image capture portion 120 captures an image of the subject PS, and generates raw image data N1 which is then recorded to the first frame memory 125 (Step S10).

Once the raw image data N1 is recorded to the first frame memory 125, the pointer detection module 140, using a known pattern matching method, analyzes the raw image data N1 (Step S12) and decides whether an image representing the pointer PR was detected in the raw image data N1 (Step S14).

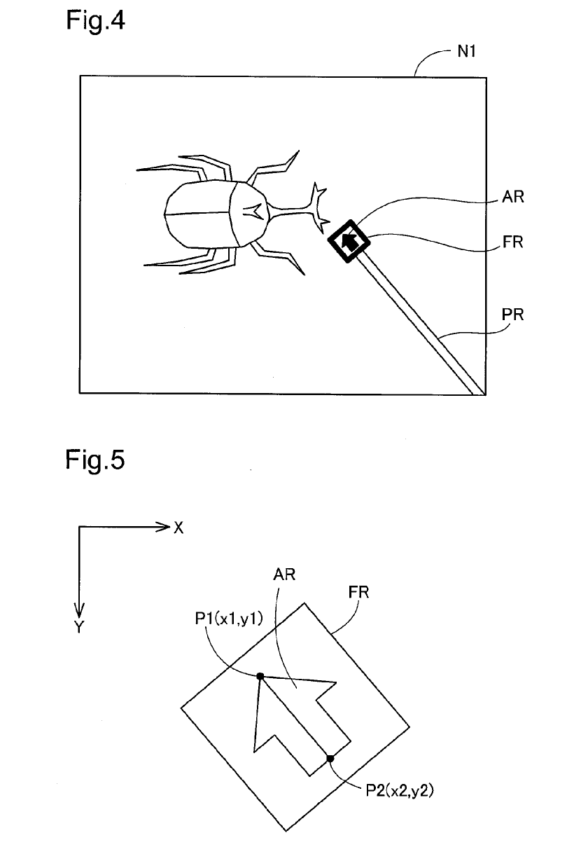

FIG. 4 is an illustration depicting the pointer PR present in raw image data N1. In the present embodiment, the distal end of the pointer PR is provided with a member having a design in which an arrow AR is arranged within a rectangular frame FR. Thus, the pointer detection module 140 first detects the rectangular frame FR in the raw image data N1 based on the known pattern matching method. If the rectangular frame FR is detected in the raw image data N1, the pointer detection module 140 decides that the pointer PR was detected in the raw image data N1. If on the other hand the rectangular frame FR is not detected in the raw image data N1, the pointer detection module 140 decides that the pointer PR was not detected in the raw image data N1.

If decided in Step S14 that the pointer PR was detected in the raw image data N1, the pointer detection module 140 then performs detection of the specified location and the specified direction (Step S16).

FIG. 5 is an illustration depicting a method of detecting specified location and specified direction. In FIG. 5, the rectangular frame FR and the arrow AR shown in FIG. 4 are represented in simplified form. In the preceding Step S16, the pointer detection module 140 first detects the arrow AR arranged inside the rectangular frame FR based on the known pattern matching method. It then detects the location P1 (x1, y1) of the tip of the arrow AR and the location P2 (x2, y2) of the back end of the arrow, and determines the detected location of the tip of the arrow AR to be the specified location. The direction of a vector extending from the back end location P2 (x2, y2) towards the location P1 (x1, y1) of the tip is determined to be the specified direction.

In Step S16, once the specified location and specified direction are detected, the pointer image generation module 145 generates a pointer image PT that points to the detected specified location from the detected specified direction (Step S18). If on the other hand the pointer PR was not detected in Step S14, the process of Step S16 and Step S18 discussed above are skipped, and no pointer image is generated.

Next, the synthesized image generation module 150 reads out the still image data N2 from the second frame memory 135 (Step S20). The synthesized image generation module 150 then synthesizes the pointer image PT generated in Step S18 with the still image data N2 to generate synthesized image data (Step S22). If the pointer PR was not detected in Step S14, generation of the pointer image PT in Step S18 does not take place, and thus neither does synthesis of the pointer image PT with the still image data N2 take place in Step S22. Thus, in this case, the synthesized image data obtained in Step S22 represents the unmodified still image data N2.

Once synthesized image data is generated in Step S22, the image output module 155 and the image encoding module 160, on the basis of a mode signal received from the still image generation module 130, decide whether the current image output mode is the still image mode (Step S24). If the current image output mode is the motion video mode, the image output module 155 and the image encoding module 160 output the raw image data N1 that was recorded to the first frame memory 125 in Step S10 (Step S26). On the other hand if the current image output mode is the still image mode, the image output module 155 and the image encoding module 160 output the synthesized image data that was generated in Step S22 (Step S28).

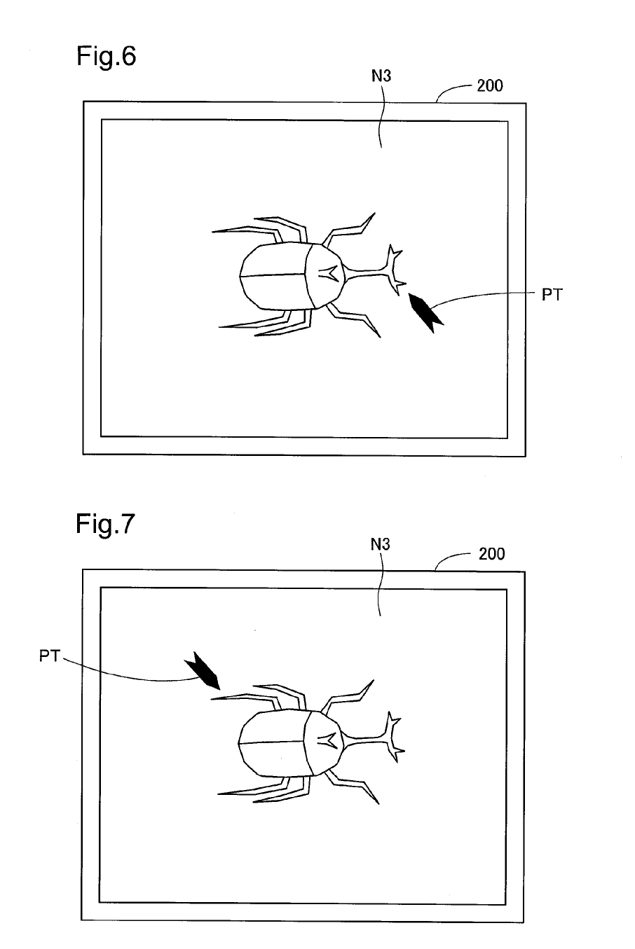

FIGS. 6 and 7 are illustrations depicting examples of display of synthesized image data N3 on the liquid crystal display 200. These drawings respectively show examples in which the pointer image PT is displayed pointing in different directions, according to the pointing direction of the PR. In FIGS. 6 and 7 the pointer image PT is shown as an image having a different form from the pointer PR, but the pointer image PT could have a form resembling the pointer PR.

According to the presentation device 100 of the embodiment described above, the pointer image PT is generated on the basis of the location and direction of the pointer PR detected in the raw image data N1 successively recorded to the first frame memory 125, and this pointer image is synthesized with the still output to the liquid crystal display 200. In the present embodiment, the pointer image PT synthesized into the still image in this way indicates the same direction as the pointing direction of the pointer PR. Thus, even if the presentation device 100 is outputting a still image, it is possible for the user to point to any location on the still image by an operation comparable to that during output of a motion video image.

### C. Modified Examples

It is to be understood that while the invention has been shown herein in terms of a preferred embodiment, there is no intention to limit the invention thereto, and various alternative aspects are possible within the spirit and scope of the invention. Possible modifications include the following, for example.

### C1. Modification 1:

In the preceding embodiment, the pointer image PT synthesized onto the still image indicates the same direction as the pointer PR. In addition, the pointer image PT synthesized onto the still image may be given the same color as the pointer PR. With this feature, it is possible to improve visibility of the pointer image PT when switching image output mode. The color of the pointer PR may be determined automatically during pattern matching, or established beforehand.

### C2. Modification 2:

In the preceding embodiment, the image display process depicted in FIG. 3 was carried by the ASIC that constitutes the still image generation module 130, the pointer detection module 140, the pointer image generation module 145, the synthesized image generation module 150, the image output module 155, and the image encoding module 160. However, the image display process may be carried out through software by a microcomputer furnished with a CPU, RAM, and ROM.

### C3. Modification 3:

In the preceding embodiment, the tip of the pointer PR was provided with a member having a design with an arrow AR positioned inside a rectangular frame FR. However, the design is arbitrary, and other designs are possible provided that the design has detectable location and direction.

What is claimed is:

1. A presentation device comprising:
an image capture portion for capturing a subject at prescribed time intervals to generate successive raw images;
a first storage portion to which the generated raw images are successively saved;
a second storage portion to which one of the generated raw images is saved as a still image;
a detection portion adapted to analyze raw images stored in the first storage portion to ascertain if a prescribed indicator member is included therein, and if the indicator member is included in the raw images, to detect the location and direction of pointing of the indicator member;
a pointer image generation portion adapted to generate a pointer image showing the detected location and direction;
a synthesized image generation portions adapted to read out the still image from the second storage portion and synthesize the pointer image with the still image to generate a synthesized image; and
an output portion for outputting the synthesized image.
